(19) United States
(12) Patent Application Publication
(10) Pub. No.: US 2014/0332102 A1
(43) Pub. Date: Nov. 13, 2014

(54) WATER AND ENERGY SAVING FAUCET STRUCTURE

(71) Applicant: Hsiang-Shih Wang, Changhua (TW)

(72) Inventor: Hsiang-Shih Wang, Changhua (TW)

(73) Assignee: GEANN INDUSTRIAL CO.,LTD., CHANGHUA (TW)

(21) Appl. No.: 14/444,553

(22) Filed: Jul. 28, 2014

Related U.S. Application Data
(60) Provisional application No. 61/765,601, filed on Feb. 15, 2013.

(51) Int. Cl. F16K 11/078

(52) U.S. Cl. CPC F16K 11/0787
USPC 137/624.27

(57) ABSTRACT

A faucet structure comprises a faucet body and a check valve. The check valve comprises a valve body, a control unit, a movable valve piece, a fixed valve piece and a valve base. The movable valve piece has a mixing cavity, at least one flow channel that is connected with the mixing cavity. The fixed valve piece has an outlet hole through the central axis, a cold water inlet hole disposed at one side of the outlet hole, and a hot water inlet hole disposed at the other side. The flow passage is positioned that when the handle of the faucet body is positioned in the middle, the mixing cavity and the flow channel of the movable valve piece align with the flow passage.

### FIELD OF THE INVENTION

This invention is related to a faucet structure, and more particularly to a faucet structure, which prevents the discharge of hot water when only cold water is needed and prevents the water hammer effect.

### BACKGROUND OF THE INVENTION

Conventional faucets usually have the check valve structure shown in FIGS. 12 and 13 or in U.S. Pat. No. 6,845,917 B1. The check valve comprises a valve body 30, a regulating seat 40, an upper switching control valve 50, a lower switching control valve 60, and a switching control base 70. The valve body 30 has a housing chamber 31 disposed at the center thereof for the regulating seat 40 with a control stick 41 joined thereto to be adapted therein. The regulating seat 40 thereof is matched to the upper switching control valve 50, the lower switching control valve 60, and the switching control base 70 thereof. The upper switching control valve 50 has a regulating cavity 51 of proper width and length disposed at the center of the lower bottom thereof, and a slant plane facet 511 defining at one front side of the regulating cavity 51 in a trapezoid-like design. A pair of cold/hot water inlet holes 61, 62 with slant sides 611, 621 defined at one long side thereof respectively are symmetrically disposed at one side of the lower switching control valve 60, while a water outlet hole 63 is provided at the middle of the other side thereof. The regulating cavity 51 thereof is matched to the cold/hot water inlet holes 61, 62 and the water outlet hole 63 of the lower switching control valve 60, and to cold/hot water inlet passages 71, 72 and a water outlet passage 73 of the switching control base 70 thereof.

In practical use, the handle of a faucet is lifted upwards from the center or to the right for the discharge of cold water, moving the control stick 41 of the regulating seat 40 to activate the upper switching control valve 50 therewith. The upper switching control valve 50 will slide forwards, and the slant plane facet 511 of the regulating cavity 51 will move therewith to align in parallel with the slant side 621 of the hot water inlet hole 62 to seal up the discharge of hot water. Meanwhile, the cold water inlet hole 61 of the lower switching control valve 60 is revealed for cold water coming through the cold water inlet passage 71 of the switching control base 70 to flow there from into the regulating cavity 51 and channeled thereby to be discharged for use via the water outlet hole 63 and the water outlet passage 73 of the lower switching control valve 60 and the switching control base 70 thereof respectively.

However, the conventional faucet structure has two problems. First, a common feature of the conventional faucet structure is the existence of the water hammer effect. When the valve is closed, the movement of water in the pipeline system is suddenly obstructed, and the velocity of water causes the compression of water in the pipeline and the increase of water pressure in the pipeline. The water pressure inside the pipeline system may cause damages to the pipeline or the faucet. Second, the trapezoid-like design of the regulating cavity 51 increases its width as well as the sizes of the cold/hot water inlet holes 61, 62, thereby failing to achieve the purpose of water conservation.

### SUMMARY OF THE INVENTION

The conventional faucet structure cannot prevent the water hammer effect and fails to achieve the purpose of water conservation.

To solve the problems stated above, the present invention provides a faucet structure comprising a faucet body and a check valve. The check valve comprises a valve body, a control unit, a movable valve piece, a fixed valve piece and a valve base. The faucet body comprises a spout, a valve housing chamber, in which the check valve is disposed, and a handle. The handle is connected with the check valve. By operating the handle, the water flow can be controlled and the ratio of hot water to cold water can be changed. The valve body has a housing chamber, and a through-hole. The control unit has a control stick, a base, and a plural of driving sticks disposed at the bottom of the base. The control stick is connected with the handle of the faucet body through the through-hole of the control unit. The movable valve piece has a mixing cavity, at least one flow channel that is connected with the mixing cavity, and a plural of engaging grooves on the top that mate with the driving sticks. The fixed valve piece has an outlet hole through the central axis, a cold water inlet hole disposed at one side of the outlet hole, and a hot water inlet hole disposed at the other side. The cold water inlet hole is arched and has a flow passage at one side of the hole, which extends towards the hot water inlet hole across the central line. The flow passage is so positioned that when the handle of the faucet body is positioned in the middle, the mixing cavity and the flow channel of the movable valve piece align with the flow passage. The hot water inlet hole is disposed at the other side of the central line. The fixed valve piece has a plural of insert slots in its circumferential region. The valve base has a plural of upward claws and insert blocks, and therefore the valve base can be attached to the valve body.

The faucet structure provided by this invention has the following advantages. First, the addition of the flow passage and the disposition of the hot water inlet hole avoid the alignment of the mixing cavity with the hot water inlet hole when the handle is in the middle position, thereby preventing unnecessary discharge of hot water and enabling conservation of energy. When cold water is frequently used, this design also prevents the unnecessary operation of water heaters. Second, the faucet structure provided in this invention can be used in combination with most kinds of faucet body in the market. Third, when turning off the water flow, the addition of the flow channel enables water to flow out of the outlet hole through the mixing cavity and the flow channel when the mixing cavity is completely sealed up, thereby preventing the water hammer effect and the damage it causes to the pipeline system. Fourth, the arch-like design of the cold water inlet hole effectively enables water conservation.

### BRIEF DESCRIPTION OF THE DRAWINGS

FIG. 1 illustrates a perspective view of the faucet structure in this invention.

FIG. 2 illustrates a perspective view of the check valve in this invention.

FIG. 3 illustrates a three-dimensional exploded view of the check valve in this invention.

FIG. 4 illustrates a two-dimensional view of the fixed valve piece in this invention.

FIG. 5 illustrates a view of the fixed valve piece and the movable valve piece when the water is turned off.

FIG. 6 illustrates a view of the check valve when the water is turned on.

FIG. 7 illustrates a view of the fixed valve piece and the movable valve piece when only cold water is discharged.

FIG. 8 illustrates a view of the check valve when the control stick is rotated.

FIG. 9 illustrates a view of the fixed valve piece and the movable valve piece when both cold water and hot water are discharged.

FIG. 10 illustrates a view of the fixed valve piece and the movable valve piece when only hot water is discharged.

FIG. 11 illustrates a view of the check valve in this invention when used in combination with another faucet body.

FIG. 12 illustrates a three-dimensional view of the check valve in the prior art.

FIG. 13 illustrates a two-dimensional view of the check valve in the prior art when only cold water is discharged.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

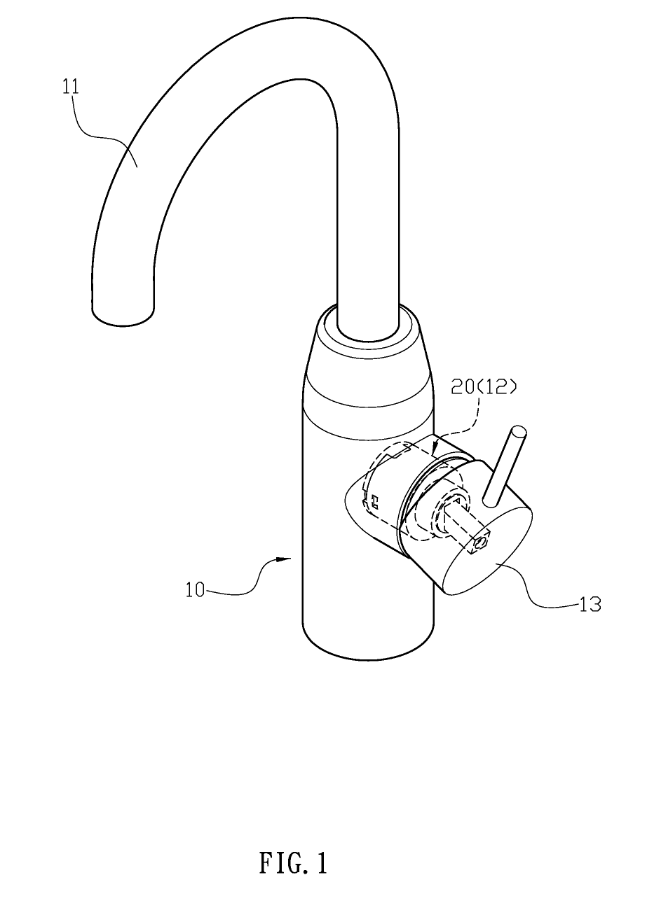

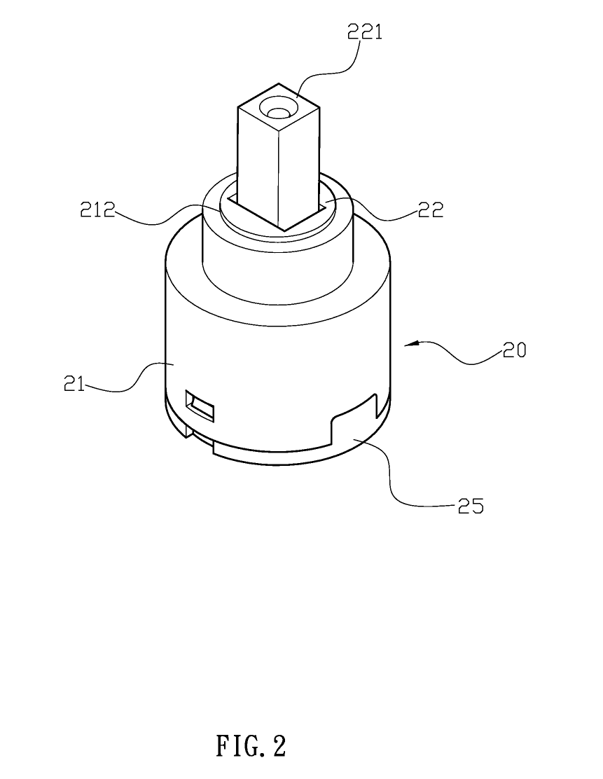

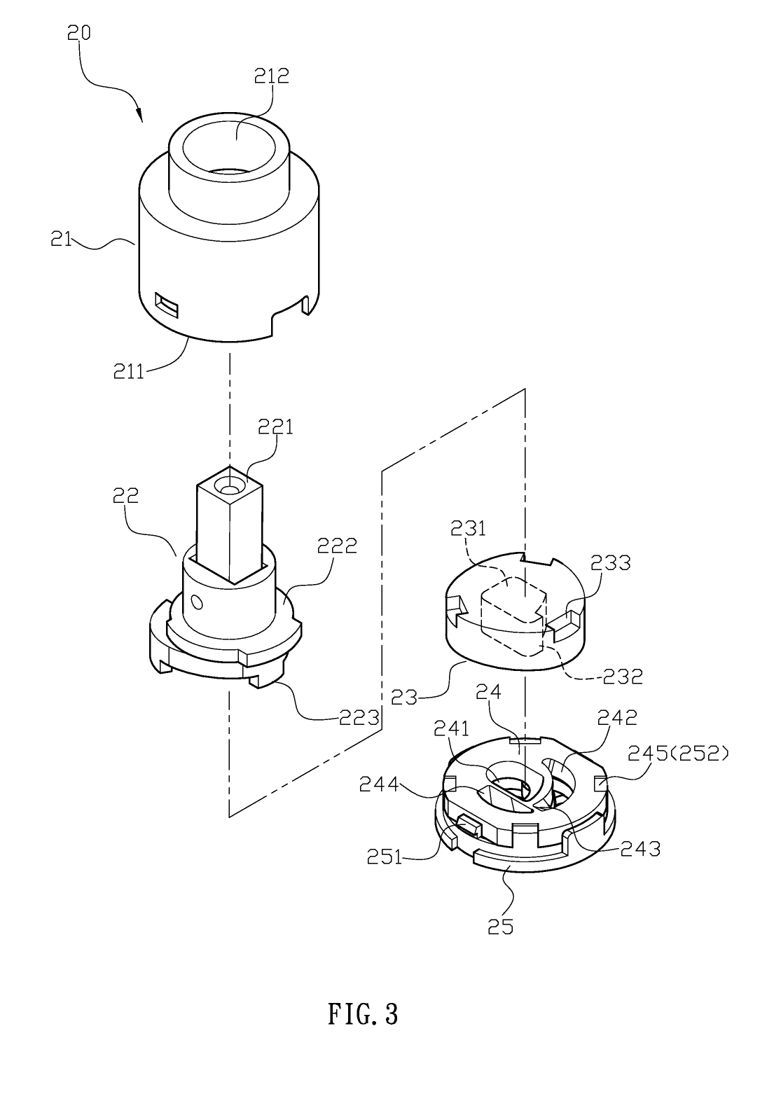

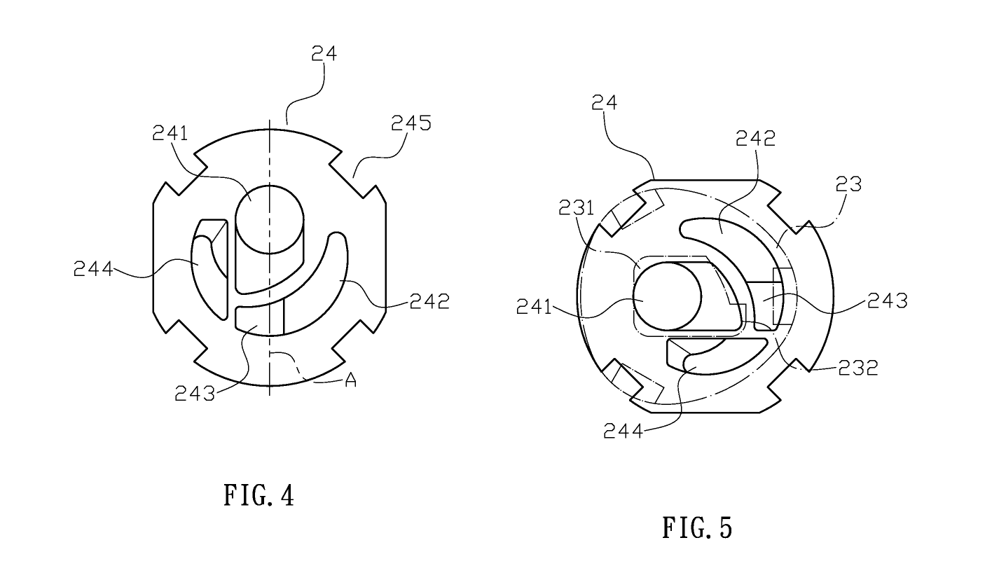

Referring to FIGS. 1 to 5, in a preferred embodiment, a faucet structure comprises a faucet body 10 and a check valve 20. The check valve 20 comprises a valve body 21, a control unit 22, a movable valve piece 23, a fixed valve piece 24 and a valve base 25. The faucet body 10 comprises a spout 11, a valve housing chamber 12, in which the check valve 20 is disposed, and a handle 13. The handle 13 is connected with the check valve 20. By operating the handle 13, the water flow can be controlled and the ratio of hot water to cold water can be changed. The valve body 21 has a housing chamber 211 and a through-hole 212. The control unit 22 has a control stick 221, a base 222, and a plural of driving sticks 223 disposed at the bottom of the base 222. The control stick 221 is connected with the handle 13 of the faucet body 10 through the through-hole 212 of the control unit 22. The movable valve piece 23 has a mixing cavity 231, at least one flow channel 232 that is connected with the mixing cavity 231, and a plural of engaging grooves 233 on the top that mate with the driving sticks 223. The fixed valve piece 24 has an outlet hole 241 through the central axis, a cold water inlet hole 242 disposed at one side of the outlet hole 241, and a hot water inlet hole 244 disposed at the other side. The cold water inlet hole 242 is arched and has a flow passage 243 at one side of the hole 242, which extends towards the hot water inlet hole 244 across the central line A. The flow passage 243 is so positioned that when the handle 13 of the faucet body 10 is positioned in the middle, the mixing cavity 231 and the flow channel 232 of the movable valve piece align with the flow passage 243. The hot water inlet hole 244 is disposed far away from line A at the other side. The fixed valve piece 24 has a plural of insert slots 245 in its circumferential region. The valve base 25 has a plural of upward claws 251 and insert blocks 252, and therefore the valve base 25 can be attached to the valve body 21.

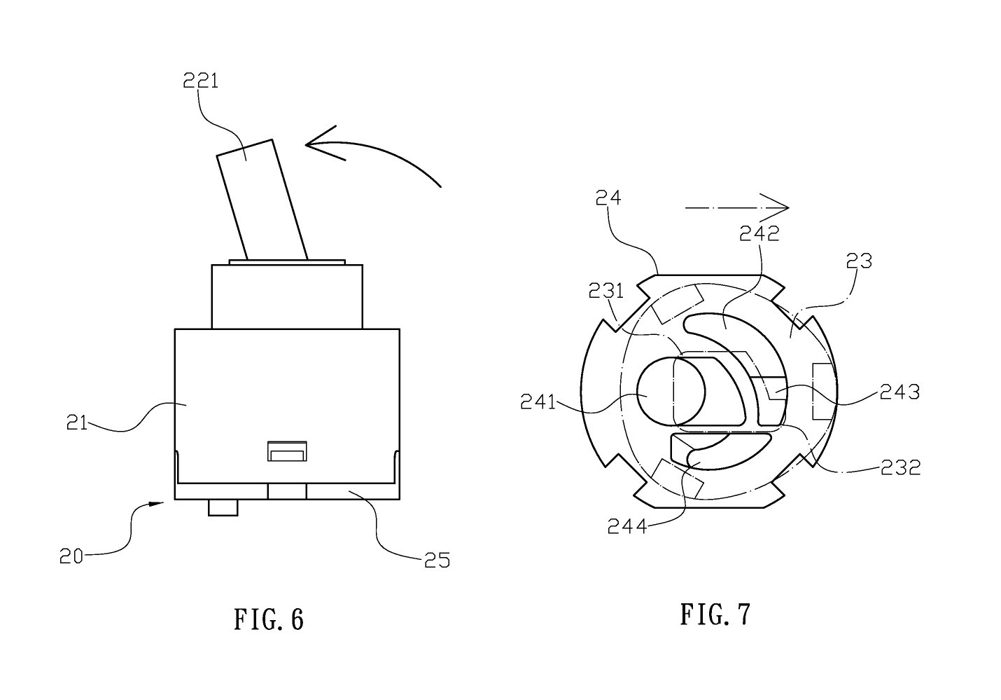

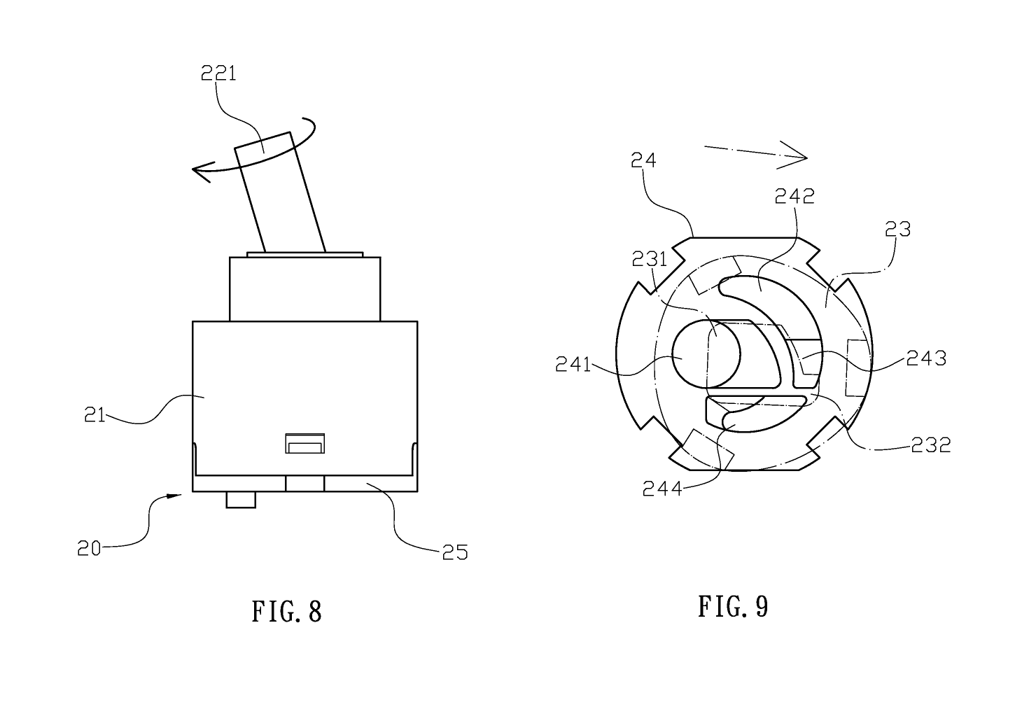

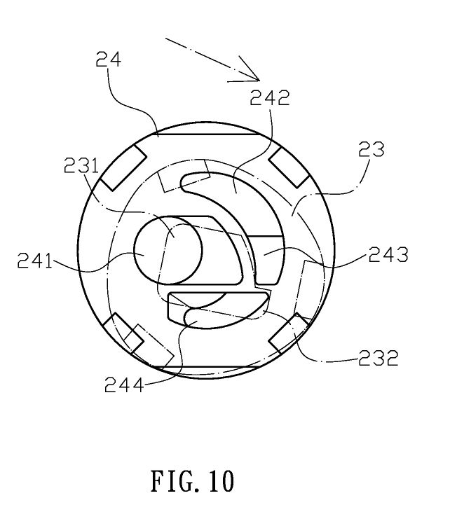

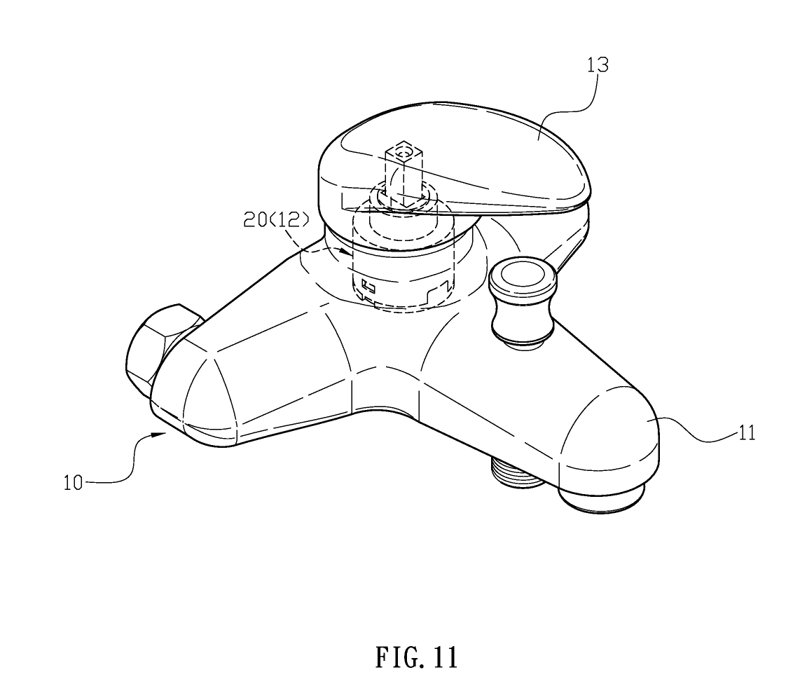

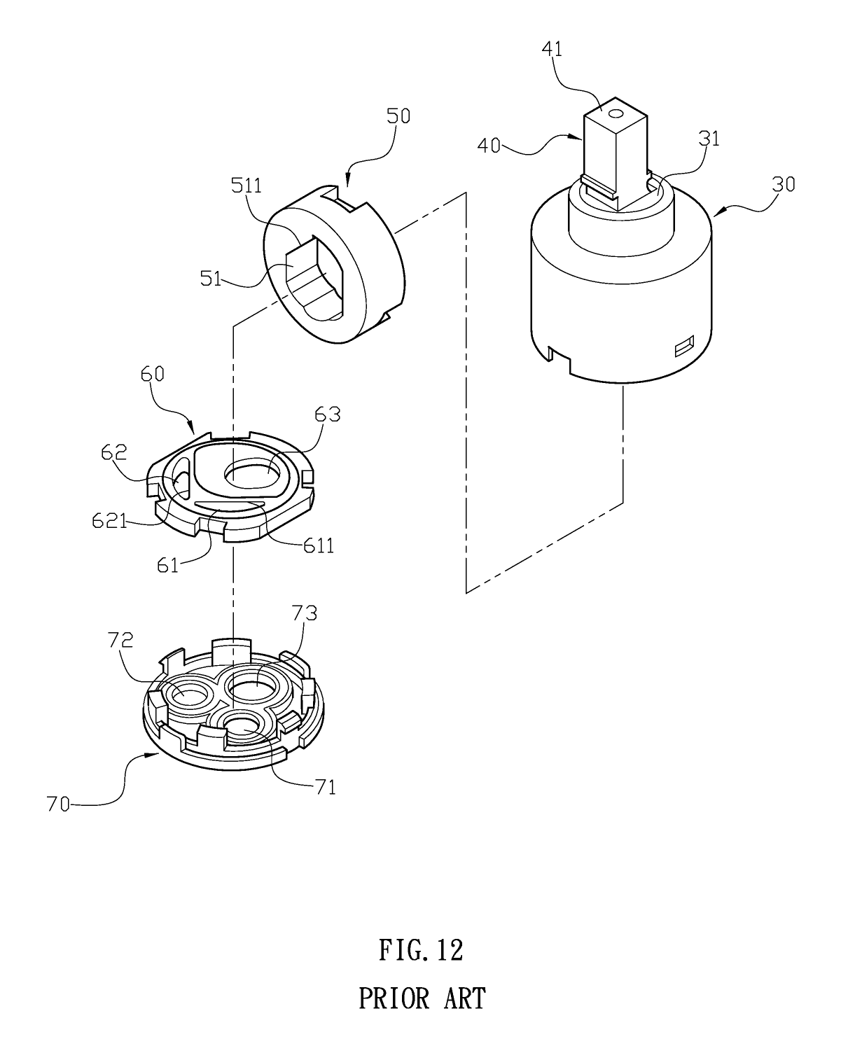

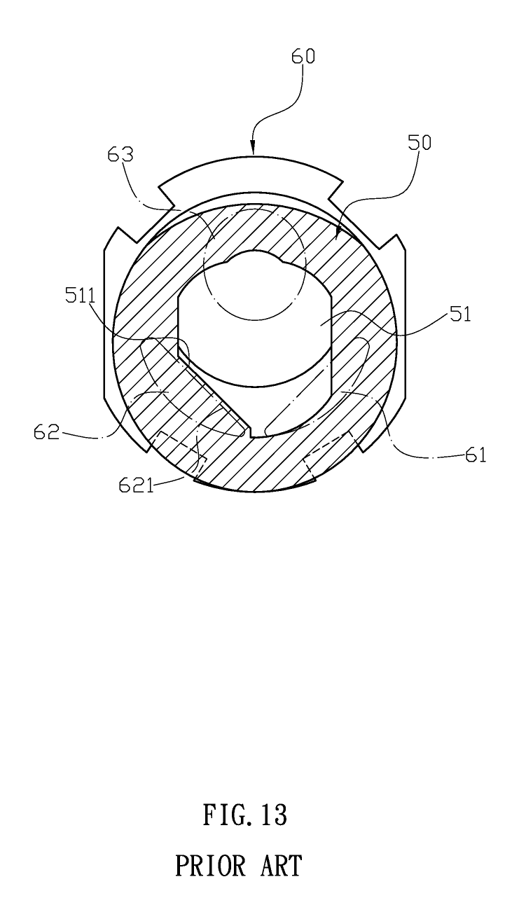

Referring to FIG. 6, in practical use, the handle 13 is lifted upward, causing the movable valve piece 23 of the check valve 20 to move and only the mixing cavity 231 and the flow channel 232 aligned with the flow passage 243 and the cold water inlet hole 242 of the fixed valve piece 24. Referring to FIG. 7, cold water can flow through the check valve 20 to the spout. Since the hot water inlet hole 244 is disposed far away from line A at the other side, the hole 244 is sealed up to prevent the unnecessary discharge of hot water, thereby achieving the purpose of energy conservation. Referring to FIG. 8 to 10, when hot or warm water is needed, the handle 13 is rotated, causing the mixing cavity 231 of the movable valve piece 23 to slide towards the hot water inlet hole 244. The mixing cavity can be aligned simultaneously with the cold water inlet hole 242, the flow passage 243 and the hot water inlet hole 244 (see FIG. 9), or aligned solely with the hot water inlet hole, so as to obtain either warm or hot water.

To turn off the water flow, the handle 13 is pushed down to restore the valve piece 23, causing the mixing cavity unaligned with the cold water inlet hold 242, the flow passage 243 and the hot water inlet hold 244. In such process, water can still flow out of the outlet hole 241 through the mixing cavity 231 when the mixing cavity 231 is completely sealed up, thereby preventing the sudden obstruction of the water flow. Therefore, the water hammer effect inside the pipeline system and the damage it causes to the pipeline system can be avoided.

This invention provides a faucet structure which enables energy conservation and prevents the water hammer effect. The top portion of the outlet hole 241 of the fixed valve piece 24 is enlarged and thus water can flow through the outlet hole 241 more easily.

The faucet structure provided by this invention has the following advantages. First, the addition of the flow passage 243 and the disposition of the hot water inlet hole 244 avoid the alignment of the mixing cavity 231 with the hot water inlet hole 244 when the handle is in the middle position, thereby preventing unnecessary discharge of hot water and enabling conservation of energy. When cold water is frequently used, this design also prevents the unnecessary operation of water heaters. Second, the faucet structure provided by this invention can be used in combination with most kinds of faucet body 10 in the market. Third, when turning off the water flow, the addition of the flow channel 232 enables water to flow out of the outlet hole 241 through the mixing cavity 231 and the flow channel 232 when the mixing cavity 231 is completely sealed up, thereby preventing the water hammer effect and the damage it causes to the pipeline system. Fourth, the design of the handle 13 and the arch-like cold water inlet hole 242 can be used for water conservation.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A faucet structure comprising a faucet body and a check valve; wherein the check valve comprises a valve body, a control unit, a movable valve piece, a fixed valve piece and a valve base; wherein faucet body comprises a spout, a valve housing chamber, in which the check valve is disposed, and a handle; wherein the handle is connected with the check valve and by operating the handle, the water flow can be controlled and the ratio of hot water to cold water can be changed; wherein valve body has a housing chamber, in which the control unit is disposed, and a through hole; wherein the control unit has a control stick mounted on a base, and the control stick is connected with the handle of the faucet body through the through-hole of the valve body;
wherein the movable valve piece has a mixing cavity and at least one flow channel that is connected with the mixing cavity; wherein the fixed valve piece has an outlet hole through the central axis, a cold water inlet hole disposed at one side of the outlet hole, and a hot water inlet hole disposed at the other side; wherein the cold water inlet hole is arched and has a flow passage at one side of the hole, which extends towards the hot water inlet hole across the central line; wherein the flow passage is so positioned that when the handle of the faucet body is positioned in the middle, the mixing cavity and the flow channel of the movable valve piece align with the flow passage; wherein the hot water inlet hole is disposed far away from the central line at the other side;
wherein the movable valve piece, the fixed valve piece and the valve base are stacked and disposed in the housing chamber of the valve body; and the fixed valve piece is attached to the valve base and the movable valve piece is connected with the base of the control unit.

2. The faucet structure of claim 1, wherein the base of the control unit has a plural of driving sticks disposed at the bottom of the base; and the movable valve piece has engaging grooves on the top that mate with the driving sticks.

3. The faucet structure of claim 1, wherein the fixed valve piece has a plural of insert slots in its circumferential region; and the valve base has a plural of upward claws and insert blocks, thereby enabling the valve base to be attached to the valve body.

4. The faucet structure of claim 1, wherein the top portion of the outlet hole of the fixed valve piece is enlarged.
